(19) United States
(12) Patent Application Publication
(10) Pub. No.: US 2005/0257272 A1
(43) Pub. Date: Nov. 17, 2005

(54) Information processing unit having security function

(75) Inventor: Makiko Nakao, Nagoya (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/965,892

(22) Filed: Oct. 18, 2004

(30) Foreign Application Priority Data
Apr. 9, 2004 (JP) 2004-115187

(51) Int. Cl. H04L 9/00

(52) U.S. Cl. 726/26

(57) ABSTRACT

The present invention provides an information processing unit where logon processing using an encryption function is executed, wherein logon is authorized even if the encryption function cannot be used. The information processing unit to be provided includes an auditing section for auditing whether the configuration has been changed, and an authorization section for authorizing execution of a program and/or use of the information processing unit based on the audit result. Further a security code verification section for verifying, when auditing of the auditing section is set not to be executed, preliminarily stored security code information and input security code information.

### BACKGROUND OF THE INVENTION

1. Field of the Invention

The present invention relates to an information processing unit having a security function for preventing a third party from installing fraudulent hardware unintended by the user, and more particularly to an information processing unit which permits an exceptional logon to the OS (Operating System) even if the security function is turned off.

2. Description of the Related Art

In personal computers (hereafter PC) and servers, corporate confidential data and personal information are exposed to the danger of being stolen and leaked by vicious third parties who install external storage devices, such as a USB (Universal Serial Bus) memories. Therefore as a means of strengthening security, installing a security chip called a TPM (Trusted Platform Module) on a PC is possible. Security chips are managed by an organization called TCG (Trusted Computing Group), which also manages the creation of specifications and technical licensing.

According to the equipment auditing function of the security chip, the pre-registered equipment configuration and the equipment configuration detected by BIOS (Basic Input/Output System) when the PC is started up are compared using a mechanism that BIOS detects the hardware mounted on the PC, and if results do not match, the logon to the OS can be disabled.

Logon to the OS involves inputting the account information of the user (in many cases a combination of the user name and password) to the PC, and if logon is disabled, the input becomes invalid even if accurate account information is input. Even if the comparison result of the equipment configuration does not match, the disabled logon to the OS is cancelled if the equipment configuration is returned to the status at registration, and the PC is restarted, where another opportunity to input the account information of the user is provided.

Also as a means of strengthening security against the stealing and leaking of the account information itself, the use of an encryption function of the security chip is possible. The security chip has an encryption key internally, by which for example, the password to be used for an application, can be encrypted. There is no way to readout the encryption key held by the security chip, so encrypted information can be managed safely.

As a logon procedure when a security chip is used, the user first turns the power of the PC ON, and logs on as an authorized user after the OS has started. In other words, the user inputs the accurate user name and password. Then the account information for verification which was stored in the PC in advance and the account information which was input are compared, and logon succeeds when both information match. And the user encrypts the account information using the security chip, and stores it on the hard disk of the PC. At this time, the access password for using the encryption/decryption function of the security chip is also set.

In the next or later logon, the access password is input instead of the account information, then the account information decrypted by the security chip is verified with the account information for verification, and logon succeeds if both information match. By this, even if the account information is stolen, information on the PC cannot be accessed unless the access password for the chip is captured by others, which can strengthen security. The security can also be further improved by encrypting the access password for the chip itself by the security chip.

As a technology related to the information processing unit for implementing security protection, Japanese Patent Application Laid-Open No. H7-191776 discloses a PC having a processor for detecting the opening of a computer body, which is set in security protection status using an optional switch, by an unauthorized user, and storing the opened status in the CMOS memory.

### SUMMARY OF THE INVENTION

However, in a PC etc. where a security chip is mounted, in some cases a user cannot always return the equipment configuration to the status at registration. Examples of such cases are when the hardware must be changed due to hardware failures, or when a third party steals hardware mounted in a PC. In such cases, the configuration at registration and the configuration of equipment when equipment auditing is executed are different, so logon is disabled unless the equipment auditing function is turned OFF.

For this, the security chip must be disabled, but if the security chip is disabled, the encryption function is also turned OFF, and an application that uses the encryption function can no longer be used. For example, when logon for an application is executed using the encryption function, the logon is disabled and the application cannot be used. If the application is the OS, then the information processing unit itself cannot be used.

With the foregoing in view, it is an object of the present invention to provide an information processing unit that can execute logon, even if the results of equipment auditing do not match, in an information processing unit on which a security chip having the equipment auditing function and encryption function is mounted, and a method and a program related thereto.

The above object is achieved by the first aspect of the present invention to provide an information processing unit, including an auditing section auditing whether a configuration of the information processing unit has been changed based on a predetermined equipment configuration information on the configuration of the information processing unit, and an authorization section authorizing execution of a program and/or use of the information processing unit based on an audit result of the auditing section. The information processing unit further includes a storage section storing security code information, and a security code verification section verifying security code information of the storage section and a security code information which was input for authorizing the execution and/or the use when auditing of the auditing section is set as not to be executed.

The above object is also achieved by the second aspect to provide an information processing unit, including an auditing section collecting first configuration information on a current configuration of the information processing unit and auditing, and a first authorization section authorizing execution of a program and/or use of the information processing unit based on an audit result of the auditing section. The information processing unit is connected to an external storage device storing second configuration information with which the execution and/or the use is authorized. The information processing unit further includes a second authorization section comparing the first configuration information and the second configuration information when the execution and/or the use is not authorized by the first authorization section, so as to judge the authorization of the execution and/or the use.

The above object is also achieved by the third aspect, to provide the information processing unit according to the second aspect, further including a storage section storing third configuration information with which the execution and/or the use of the information processing unit is authorized. When the first authorization section compares the first configuration information and the third configuration information and cannot authorize the execution and/or the use, the first authorization section compares the first configuration information and the second configuration information.

The above object is also achieved by the fourth aspect to provide the information processing unit according to the second aspect, wherein the external storage device is a portable storage medium that is removable from a reader.

The above object is also achieved by the fifth aspect to provide the information processing unit according to the first or second aspect, wherein the program is a program that is executed by the information processing unit.

The above object is also achieved by the sixth aspect to provide a storage medium in which a program causing a computer to execute a security code verification procedure is stored. The computer has an auditing section auditing whether a configuration of the computer has been changed based on a predetermined equipment configuration information on the configuration of the computer, and an authorization section for authorizing execution of a program and/or use of the computer based on an audit result of the auditing section. Then in the code verification procedure, a security code information stored in a storage section for authorizing the execution and/or the use and the security code information which was input are verified when auditing of the auditing section is set not to be executed.

The above object is also achieved by the seventh aspect to provide a storage medium in which a program causing a computer to execute a security code verification procedure is stored. The computer has an auditing section collecting first configuration information on a current configuration of the computer and auditing, and an authorization section authorizing execution of a program and/or use of the computer based on an audit result of the auditing section. Also, the computer is connected to an external storage device for storing second configuration information with which the execution and/or the use is authorized. Then in the authorization procedure, the authorization of the execution and/or the use by comparing the first configuration information and the second configuration information is judged when the execution and/or the use is not authorized by the authorization section.

The above object is also achieved by the eighth aspect, to provide the storage medium according to the seventh aspect for having the computer further execute a first comparing procedure in which the authorization section compares the first configuration information and a third configuration information that is stored in a storage section and with that the execution and/or the use is authorized. The program causes the computer further execute a second comparing procedure in which the first configuration information and the second configuration information are compared when the execution and/or the use cannot be authorized based on result of the first comparison procedure.

The above object is also achieved by the ninth aspect to provide the storage medium according to the seventh aspect, wherein the external storage device is a portable storage medium that is removable from a reader.

The above object is also achieved by the tenth aspect to provide the storage medium according to the sixth or seventh aspect, wherein the program to be the target of the execution authorization is a program that is executed by the computer.

According to the present invention, even if the security chip is turned OFF and the encryption function cannot be used, for example, when the equipment configuration is changed and the equipment auditing failed because of the difference of the equipment configuration at registration and the current equipment configuration, logon to the OS can be authorized for the user by inputting an emergency password. Also in logon processing using the encryption function of the security chip, when the equipment auditing function detects mismatch between current configuration and registered configuration, for example, input of an access password is requested to enable the encryption function, and logon processing is executed by decrypting the encrypted account information only when an accurate access password is input, so the security level against the stealing of account information can be increased.

### BRIEF DESCRIPTION OF THE DRAWINGS

FIG. 1 is a block diagram depicting the configuration of the information processing unit according to an embodiment of the present invention;

FIG. 2 shows data configuration examples of the data to be stored on a hard disk, where A is the case of status information 103, B is the account information 104, and C is the encrypted account information 107;

FIG. 3 is a flow chart depicting the operation in the information processing unit according to the present embodiment;

FIG. 4 is a flow chart depicting the operation in the information processing unit according to the present embodiment;

FIG. 5 is a flow chart depicting the operation in the information processing unit according to the present embodiment;

FIG. 6 is a snap shot of a screen example that appears in the flow chart;

FIG. 7 is a snap shot of a screen example that appears in the flow chart;

FIG. 8 is a snap shot of a screen example that appears in the flow chart;

FIG. 9 is a snap shot of a screen example that appears in the flow chart;

FIG. 10 is a snap shot of a screen example that appears in the flow chart; and

FIG. 11 is a snap shot of a screen example that appears in the flow chart;

### DESCRIPTION OF THE PREFERRED EMBODIMENTS

Embodiments of the present invention will now be described with reference to the drawings. The technical scope of the present invention, however, is not limited by the embodiments, but extend to the inventions stated in the claims and equivalents thereof.

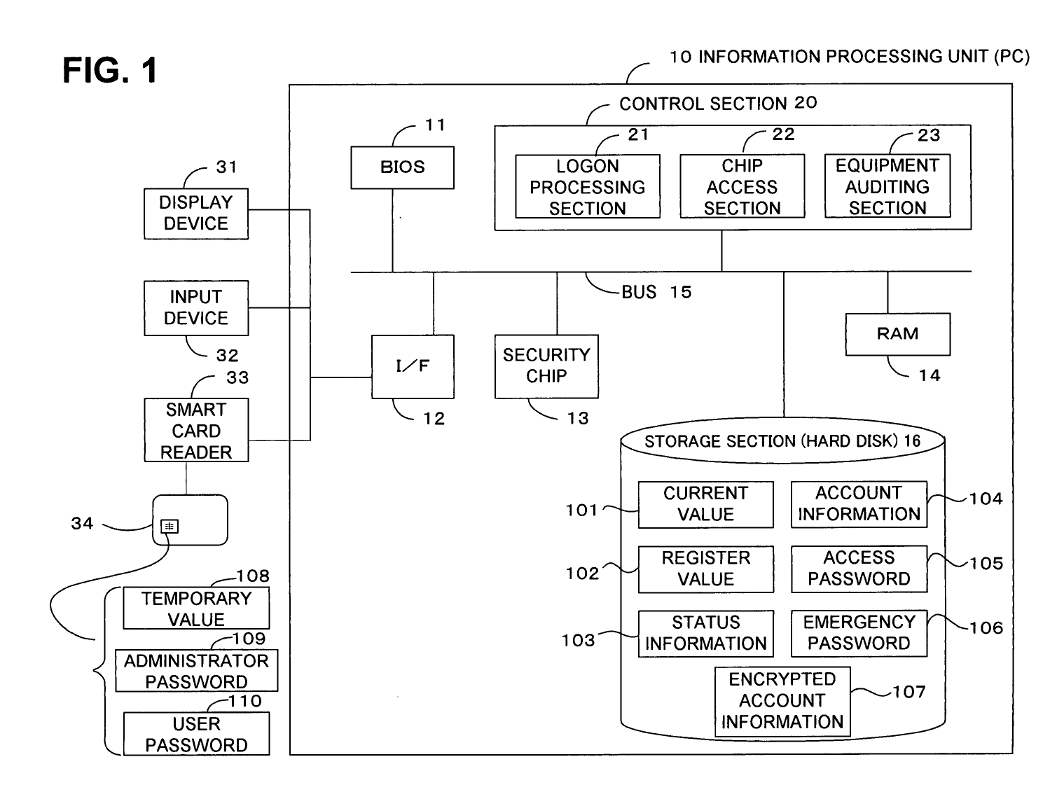

FIG. 1 is a block diagram depicting the configuration of the information processing unit according to an embodiment of the present invention. In FIG. 1, the case of a PC will be described as an example of an information processing unit. The user inputs instructions by such input devices 32 as a keyboard, mouse, touch panel and power supply button while observing the display device 31, such as a liquid crystal display, externally connected to the information processing unit 10, starts up the OS (Operating System), referred to as the basic software, and an application program (including the OS itself) which runs on the OS, such as a word processor, spreadsheet, presentation software and a game, and performs operation.

When the application program starts up on the information processing unit, a processing called the logon is performed to authorize the use of the application program to only a specific user. For this, the account information, including the user name and password, is registered in the information processing unit 10 in advance, the user inputs the user name and password at startup of the application program, and logon succeeds and use of the application is permitted when the input information matches the registered account information. If logon fails, logon processing is repeated until an accurate user name and password are input.

The logon processing described in the present embodiment is a logon processing to the OS which is executed when the OS is started. The user cannot use the OS or use the application program which runs on the OS unless a password corresponding to the user name is input. The present embodiment can also be applied to logon processing which is performed for an individual application program which runs on the OS.

To the information processing unit 10 in FIG. 1, the BIOS (Basic Input/Output System) chip 11, security chip 13, control section 20, storage section 16 and RAM (Random Access Memory) 14 are connected via the bus 15, and the display device 31, input device 32 and smart card reader 33 are externally connected via the interface (I/F) 12 for connecting peripheral equipment which is also connected to the bus 15. These connection formats may be either wire or wireless.

The BIOS chip 11 stores programs (BIOS) for detecting equipment (internal equipment and peripheral equipment) such as a disk drive, keyboard and video card, which are connected to the information processing unit 10 via the bus 15 when the information processing unit 10 is started (when power is turned ON) and for controlling this equipment, and executes the BIOS. Based on the detected equipment, equipment configuration information is generated. Equipment configuration information is text information where the vendor names and model numbers of the peripheral equipment are listed, and the hash values calculated from each product specified by the vendor name and model number.

A hash value is acquired, by calculating an original message into fixed length pseudo-random numbers through the hash function, the original message being for example, the detected vendor name or model name of the peripheral equipment. A content of the equipment configuration information (list or hash value) changes if the configuration of the processing unit is changed, so the equipment configuration information identifies the configuration of the processing unit. In the present embodiment, not the text information but the hash value is used, and is stored in the storage section 16 (current configuration hash value 101, registered configuration hash value 102).

The security chip 13 has a storage area itself and stores the equipment configuration information (current configuration hash value) which is acquired based on the equipment which the BIOS detects at starting. The current hash value 101 in the security chip 13 is accessed by the control section 20 executing the chip access program, and is stored in the storage section 16 by the control section 20.

The security chip 13 also has a function for the encryption/decryption of data. The security chip 13 is one equipment controlled by the BIOS chip 11, and ON/OFF (valid/invalid) is switched by the BIOS. If the security chip 13 in FIG. 1 is turned OFF, the current configuration hash value in the security chip 13 cannot be read, and the equipment auditing function cannot be used. Also the encryption/decryption function cannot be used. The ON/OFF status of the security chip 13 is stored in the status information of the storage section 16 by the BIOS chip 11.

The storage section 16 is a non-volatile storage means, which has a hard disk and flash memory, and includes the current configuration hash value 101 which is equipment configuration information that is generated based on the current equipment connected to the information processing unit, a registration configuration hash value 102 that is generated based on the equipment when the user registered the equipment configuration, status information 103 that includes the setup information on the status of the security chip and on equipment auditing, account information 104 where the user name and password to be used for logon to the OS are stored, access password 105 that is used when the encryption/decryption function is used, emergency password 106 that is used when change on the equipment configuration has been detected in the result of equipment auditing, and encrypted account information 107 that is the account information 104 encrypted by the security chip 13.

The RAM 14 is a storage means where the computation result to be used in the control section 20 and other data is temporarily stored. The interface for connecting peripheral equipment 12 is an interface used for connecting the external peripheral equipment to the information processing unit, and provides a USB port, serial port and parallel port, for example.

The control section 20, which includes a CPU, which is not illustrated, executes various programs and controls the information processing unit 10. A program is normally stored in the storage section 16, and is read to the RAM 14 and executed when necessary, but here, a program is illustrated as a function section to show a function which the control section 20 provides. In other words, each function section in the control section 20 is implemented by the control section 20 executing the corresponding program.

The chip access section 22, which is implemented by the control section 20 executing the chip access program, reads the current configuration hash value, which is generated when the information processing unit 10 is started, from the security chip, and stores it in the storage section 16. This is for saving the current configuration hash value, which is generated in the security chip 13, in the storage section 16. By being stored in the storage section 16, the current configuration hash value 101 can be referred to also by another program which is executed in the control section 20.

The equipment auditing section 23, which is implemented by the control section 20 executing the equipment auditing processing program, reads the current configuration hash value 101 and the registered configuration hash value 102 from the storage section 16, compares them, and judges whether an equipment change, which the user did not intend, occurred. (This processing is the equipment auditing.) The logon processing section 21, which is implemented by the control section 20 executing the logon processing program, performs logon processing for judging whether the use of an application program is authorized to the user. After it is confirmed that a change of the equipment configuration, which the user did not intend, did not occur as a result of equipment auditing, the account information to be input to the logon processing section 21 and the account information 104 stored in the storage section 16 are compared, and logon processing is performed.

When the encrypted account information 107, which will be described later, does not exist, the logon processing section 21 displays an error and requests input of a later mentioned emergency password. If the user inputs the emergency password here, input of the user name and password is requested, and the user needs to input both the user name and the password. If the security chip 13 is valid (ON), and the encrypted account information 107 exists, the logon processing section 21 performs logon processing using this account information 107.

The encrypted account information 107 is created by the security chip 13 based on an explicit instruction by the user who succeeded in logon to the OS. At this time, the account information 107 encrypted by the security chip 13 is stored in the storage section 16. When logon processing is performed, the logon processing section 21 decrypts the encrypted account information 107, and compares it with the account information 104, and it is judged as a logon success if there is a match, and as a failure if there is a mismatch.

When encrypted account information is used, once logon officially succeeds, anyone can succeed in a logon thereafter, so verification with the password for accessing the security chip 13 (access password 105) may be executed in the previous stage of decrypting the encrypted account information 107 in logon processing. This access password 105 is input to the information processing unit 10 in advance by the user, and is stored in the storage section 16.

Even if encryption account information is used, logon may fail in some cases. This is because either the account information 104 or the encrypted account information 107 is damaged (data corruption), or because the security chip 13 is OFF and the account information 104 has not yet been encrypted. If logon processing is executed using this encrypted account information 107, logon processing can be performed without imposing the user to input the user name and password.

When the current configuration hash value 101 and the registered configuration hash value 102 are different, the equipment auditing section 23 notifies the logon processing section 21 that the equipment configuration has been changed. The logon processing section 21 normally disables logon except for the case when logon is enabled even if the equipment configuration is changed. If logon is disabled, logon is judged as a failure, even if accurate account information is input.

In this case, the logon disabled state can be cancelled by returning the equipment configuration back to the equipment configuration at registration. In some cases, however, the equipment configuration cannot be returned to the equipment configuration at registration. An example of such a case is when a hard disk fails and this hard disk is no longer manufactured. Another example is during a period of equipment auditing OFF, a configuration change was repeated many times, and as a result, the original configuration at registration when the equipment auditing function was turned ON can no longer be recalled.

Even in such cases, the logon processing section 21 of the present embodiment cancels logon disable state if the password, which is input to the logon processing section 21, matches with the emergency password 106 stored in the storage section 16. And then the user is requested to input the user name and password manually, and the logon processing section 21 compares the account information which was input in this way with the account information 104, and judges a logon success if there is a match. If logon to the OS succeeds, the equipment configuration can be registered again, so logon is not disabled in the next equipment auditing.

A smart card 34 can also be used to cancel the logon disabled status. Smart card 34 is an IC card including a processor, which is not illustrated, and a memory, and has computing capability and storing capability. In the memory of the smart card, equipment configuration information (temporary use hash value 108) to be used temporarily is stored. The user who has this smart card can logon to the OS even in an emergency where logon is disabled by a change of the equipment configuration that the user did not intend.

When the smart card 34 is inserted into the smart card reader 33 connected to the information processing unit 10, the logon processing section 21 judges as a logon success if the temporary use hash value 108, stored in the smart card 34, matches with the current configuration hash value 101. Therefore if the hash value 108, to be stored in the smart card 34, is rewritten by the smart card writer (not illustrated) according to the current equipment configuration of the information processing unit, the logon disabled status is cancelled.

Also an administrator password 109 and user password 110 may be set in the smart card 34. If the user password 110 is input after the smart card is inserted, the user password 110 is verified with the above mentioned temporary use hash value 108, and if the administrator password 109 is input, the registered configuration hash value 102 is overwritten with the current configuration hash value 101, and it is judged as a logon success.

If the distribution of the smart card is limited to users who can be trusted, the smart card can be used as an emergency relief means. The administrator password and user password in this case are implemented by a code number for the smart card, called a PIN (Personal Identification Number).

The logon processing section 21, chip access section 22 and equipment auditing section 23 in FIG. 1 are implemented by the control section 20 including the CPU, which is not illustrated, executing the logon processing program, chip access program, and equipment auditing processing program, but may be implemented as hardware. The smart card reader 33 may be an internal connection type, which is enclosed in a PC. The configuration in FIG. 1 is based on the assumption that the information processing unit (main body) 1, input device 32, such as a keyboard, and display device 31, such as a CRT, are externally connected, as in the case of a desktop PC, but the present embodiment can also be applied to notebook PCs, and in this case, the input device 32 and the display device 31 in FIG. 1 may be internally connected to the information processing unit 1.

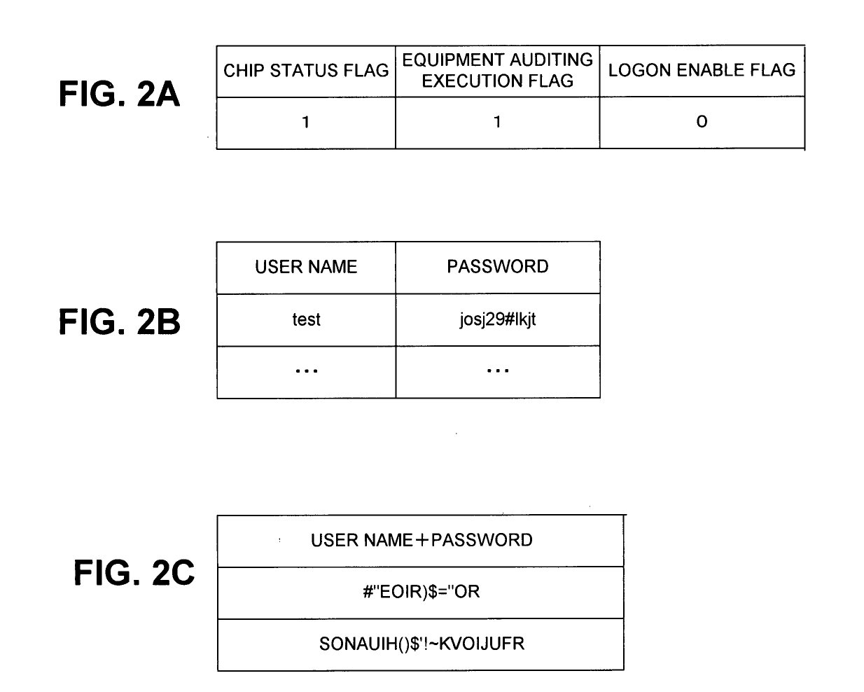

FIG. 2 shows data configuration examples of the data to be stored in the storage section 16, where FIG. 2A is a case of the status information 103, FIG. 2B is the account information 104, and FIG. 2C is the encrypted account information 107.

In FIG. 2A, a chip status flag which indicates the valid/invalid status of the security chip, an equipment auditing execution flag which determines whether equipment auditing is executing, and a logon enable flag which determines whether logon is enabled when the equipment configuration is different from that at registration are stored as the status information 103. In the chip status flag, 1 indicates that the security chip is valid (ON), and 0 indicates that the security chip is invalid (OFF). The chip status flag is updated by the BIOS chip 11, and is referred to by the logon processing section 21 and equipment auditing section 23.

In the equipment auditing execution flag, 1 indicates that equipment auditing is executed, and 0 indicates that equipment auditing is not executed even if the security chip is in valid status. The equipment auditing execution flag is referred to by the equipment auditing section 23.

In the logon enable flag, 1 indicates that logon processing is executed with displaying the warning message on the display device 31, even if the equipment configuration is different from that at registration as a result of equipment auditing, and 0 indicates that logon is disabled if the equipment configuration is different from that at registration as a result of equipment auditing. The logon enable flag is referred to by the logon processing section 21.

In FIG. 2B, the user name and password are corresponded as set and stored as the account information 104. When a plurality of users use one PC, the account information is stored for each user. The user name is in plain text, but the password is not in plain text but is converted by a predetermined algorithm. In FIG. 2C, the linked user name and password are encrypted by a predetermined algorithm as encrypted account information 107.

Now operation of the information processing unit of the present embodiment will be described.

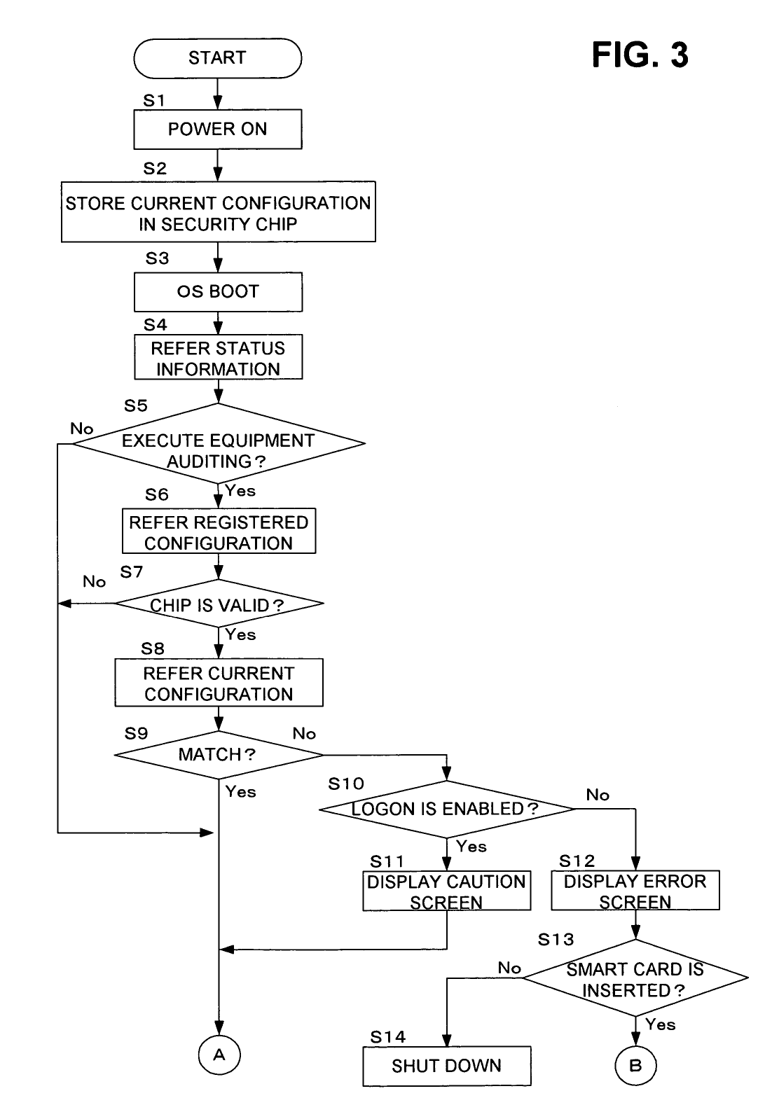

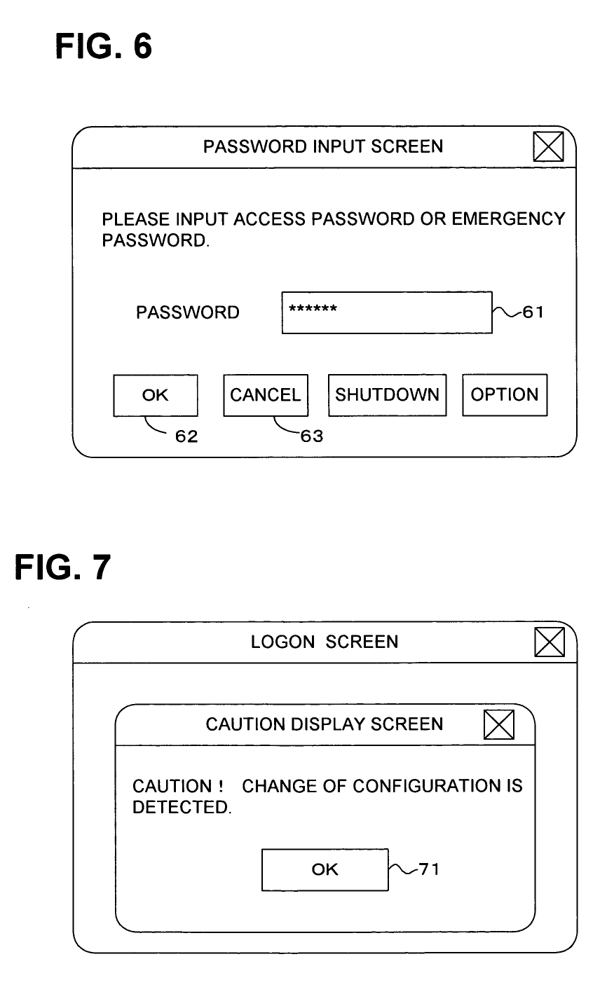

FIG. 3-FIG. 5 are flow charts depicting operation of the information processing unit according to the present embodiment. FIG. 6-FIG. 11 are snap shots of the screen examples which appear in the flow charts. The snap shots of the screen examples will be used for the description of the flow charts. In the present embodiment, it is assumed that the security chip is valid and that equipment auditing will be executed considering security.

At first, power of the information processing unit 10 is turned ON, and the information processing unit 10 is started up by the BIOS chip 11 (S1). The BIOS detects the equipment connected to the PC, and executes initialization processing. And based on the configuration of the equipment detected by the BIOS, the current configuration hash value is calculated and stored in the security chip 13 (S2). The chip access section 22 stores the current configuration hash value 101 from the security chip 13 to the storage section 16.

When step S2 ends, the OS is started up by the CPU, which is not illustrated (S3). When the OS is started, the equipment auditing section 23 acquires the status information 103 (S4). The equipment auditing section 23 refers to the equipment auditing execution flag included in the status information 103 acquired in step S4, and determines whether equipment auditing will be executed (5S). In this case, it is assumed that the equipment auditing execution flag is 1 and that equipment auditing will be executed (YES in S5).

Then the equipment auditing section 23 acquires the registered configuration hash value 102 from the storage section 16 (S6), and judges whether the status of the security chip 13 is valid or not (S7). The equipment auditing section 23 acquires the chip status flag included in the status information 103 acquired in step S4, and judges as valid if the value is 1, and as invalid if the value is 0. In this case, it is assumed that the security chip 13 is valid (YES in S7).

And the equipment auditing section 23 acquires the current configuration hash value 101 (S8), and judges whether the current configuration hash value 101 and the registered configuration hash value 102 match (S9). If both hash values match in step S9 (YES in S9), an equipment configuration change that the user did not intend did not occur.

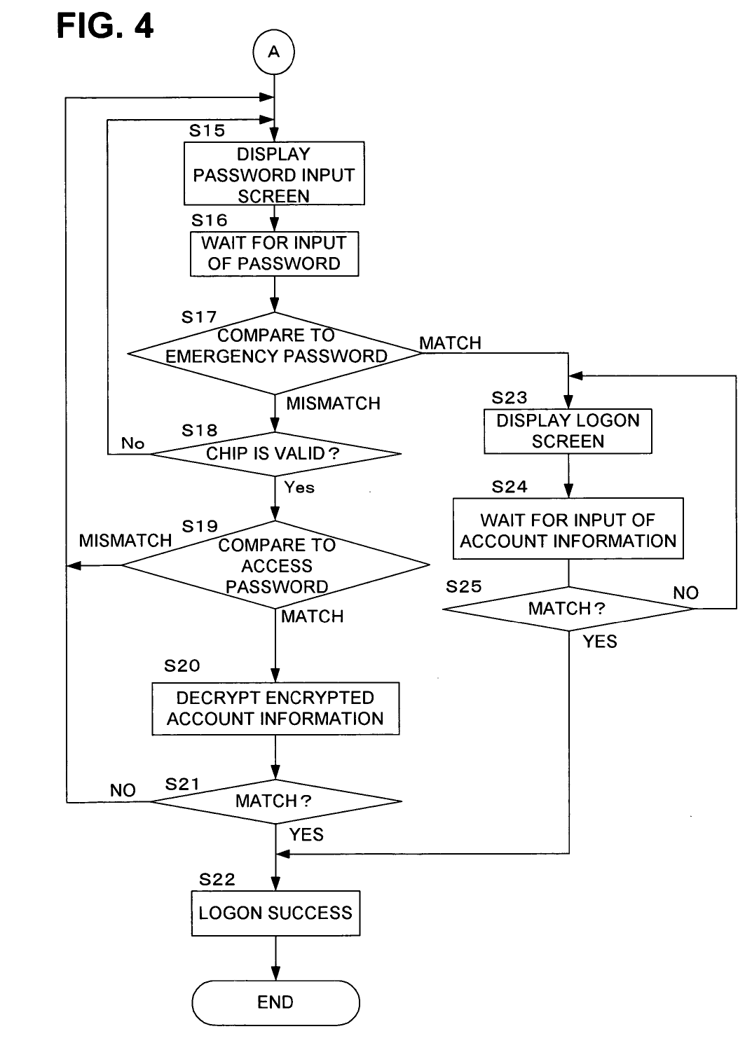

In FIG. 4, the equipment auditing section 23 notifies the logon processing section 21 that the equipment auditing ended, and the logon processing section 21 starts logon processing. And the screen for requesting input of the access password is displayed on the display device 31 (S15).

FIG. 6 is an example of a screen that is displayed in step S15. In the password column 61, the password which the user input is displayed as hidden characters. If the OK button 62 is clicked, the input is fixed and is compared with the access password 105, and if the cancel button 63 is clicked, the password can be re-input.

In FIG. 4, the logon processing section 21 waits for the input of the password (S16). When the password is input in step S16, the logon processing section 21 judges whether it matches with the emergency password 106 (S17). The emergency password is used when the equipment configuration does not match in step S9, and in this case, it is assumed that the equipment configuration does not match (MISMATCH in S17).

Then it is judged again whether the security chip 13 is valid (S18). In this case, it is assumed that the security chip is valid, just like step S7 (YES in S18). The logon processing section 21 judges whether the password which was input in step S16 matches the access password 105 (S19).

When the password input in step S16 does not match the access password 105 (MISMATCH in S19), processing returns to step S15 where another chance to input the password is provided. If it matches with the access password 105 (MATCH in S19), the logon processing section 21 decrypts the encrypted account information 107 (S20).

The logon processing section 21 compares the decrypted result of the encrypted account information 107 and the account information 104 (S21), and if they match (YES in S21), the logon processing section 21 judges it as a logon success, and authorizes the user to use the OS (S22).

This is the flow of a normal case when the equipment configuration has not been changed. If equipment auditing succeeds (YES in S9), logon to the OS succeeds and the user can start using the information processing unit 10 merely by inputting the access password.

If there is a mismatch in step S21 (NO in S21), this is the case when the account information or encrypted account information is damaged or does not exist, so processing returns to step S15. In this case, logon does not succeed unless the emergency password is input in step S17 (later illustrated).

Now back to the FIG. 3 the case when the equipment configuration was changed and the result of equipment auditing is a mismatch (NO in S9) will be described. In this case as well, the equipment auditing section 23 notifies the end of equipment auditing to the logon processing section 21, and the logon processing section 21 starts logon processing.

At first, when S9 is NO, processing advances to step S10 and it is judged whether logon is enabled (S10). Even if equipment auditing fails (NO in S9), the administrator can set that logon is enabled, and this information is stored in the status information 103 in advance as a logon enable flag.

If the logon enable flag included in the status information 103 is 1, the logon processing section 21 regards it as logon enabled (YES in S10), and a screen to prompt the user to execute equipment auditing or a screen to notify the user that the equipment configuration has been changed is displayed on the display device 30 (S11).

FIG. 7 is an example of a screen which is displayed in step S11. In FIG. 7, clicking the OK button 71 at the center advances processing to the next step. When step S11 ends, a screen to request input of the access password or an emergency password is displayed on the display device 31 (S15).

In FIG. 4, the logon processing section 21 waits for input of the password (S16). If the password is input in step S16, the logon processing section 21 judges whether the password matches with the emergency password (S17). If it matches with the emergency password (match in S17), a screen for requesting input of the user name and password to logon to the OS is displayed on the display device (S23).

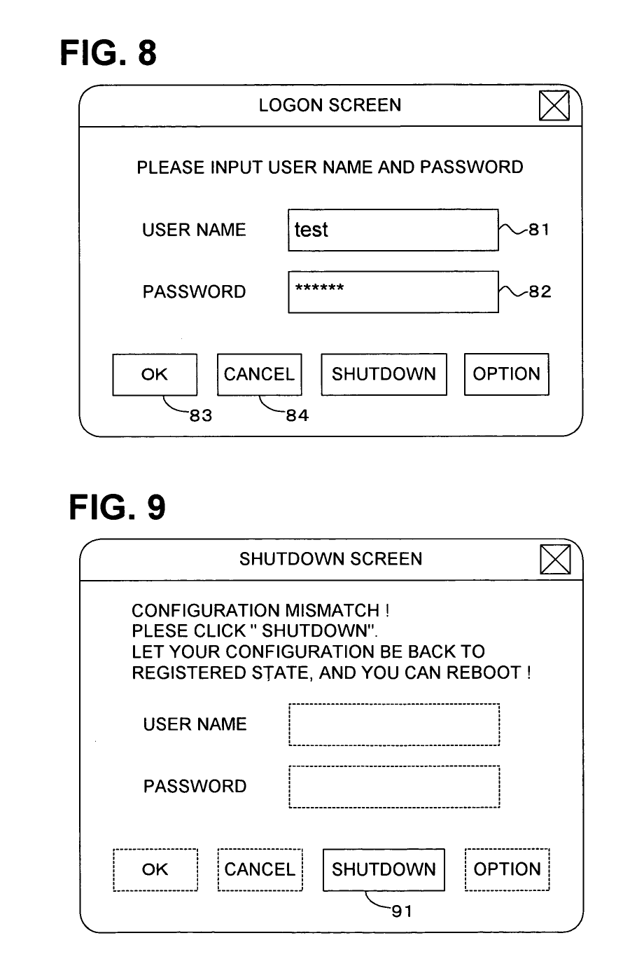

FIG. 8 is an example of a screen displayed in step S23. In the user name column 81, the user name which was input by the user is displayed, and in the password column 82, the password which was input by the user is displayed as hidden characters. If the OK button 83 is clicked, the input is fixed and is compared with the account information 104, and if the cancel button 84 is clicked, the account information can be input.

In FIG. 4, the logon processing section 21 waits for the input of the account information (S24). When the user name and password are input in step S24, the logon processing section 21 judges whether it matches with the account information 104 (S25). If it matches (YES in S25), the logon processing section 21 judges it as a logon success, and authorizes the user to use the OS (S22). If not a match (NO in S25), processing returns to step S23, and another chance to input the account information is provided.

In this way, even if equipment auditing failed (NO in S9), logon to the OS is guaranteed by the two paths, and the user can start using the information processing unit 10 without reregistering the equipment configuration or without changing the equipment configuration. One path is when the user inputs the access password in step S19 when logon is set to be enabled even if the equipment audit result is a mismatch (YES in S10). The other path is when the user inputs the emergency password, which is set in advance, in step S17. This can be used as an emergency relief means.

Next the case when the security chip 13 is invalid (OFF) will be described. If the security chip is OFF (NO in step S7), the access password or emergency password input screen is displayed in step S15 in a status where equipment auditing is skipped. Since the security chip 13 is invalid and logon processing using the encrypted account information 107 cannot be performed, step S18 is always negative (NO in S18), and processing returns to step S15. In this case, logon does not succeed unless the emergency password is input in S17.

Step S18 is executed using the chip status flag included in the status information 103, just like step S7. When the security chip 13 is valid (YES in S18), the subsequent processing is the same as the case when the equipment auditing failed but emergency password verification succeeded, so description thereof will be omitted.

Back to the FIG. 3, finally the case when the equipment configuration was changed and the result of equipment auditing is a mismatch and when logon is not enabled (NO in S10) will be described. In this case, a screen which notifies that the equipment configuration is different from that at registration and that logon cannot be enabled is displayed on the display device 30 (S12).

And the logon processing section 21 judges whether a smart card is inserted (S13). If the smart card is not inserted, a screen prompting the user to shutdown is displayed (S14), and the user shuts down the information processing unit and power is turned OFF. In this case, the user may return the equipment configuration back to the status at registration. Also the user may turn the security chip OFF by BIOS after the shutdown, and restart from step S5 in FIG. 3. Then equipment auditing (S9) is avoided since the security chip became invalid in step S7 (NO in S7), and logon to the OS becomes possible by inputting the emergency password thereafter.

FIG. 9 is an example of a screen to be displayed in step S14. On the screen, it is notified that the result of equipment auditing is a mismatch, and the user is prompted to shutdown. In FIG. 9, sections other than the shutdown button 91 are invalid, and cannot be clicked.

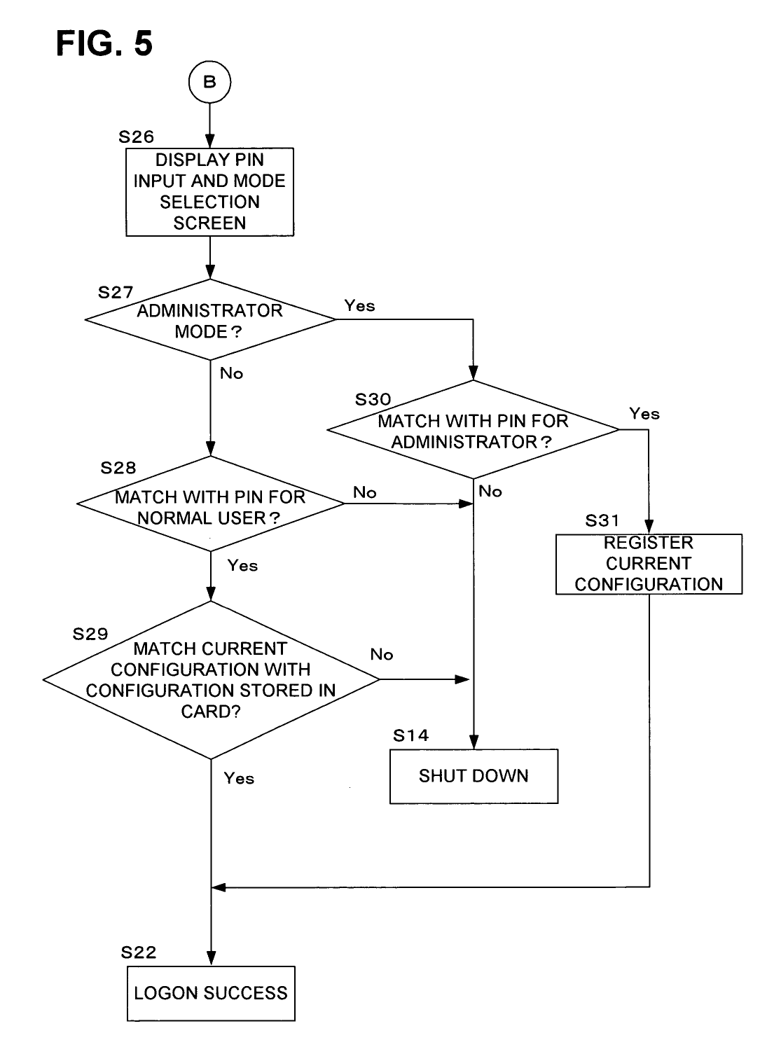

In FIG. 5, if the smart card 34 is inserted in step S13 (FIG. 3), the screen to prompt input of the mode being set in the smart card 34 and the PIN is displayed (S26). The mode being set is either administrator mode or user mode.

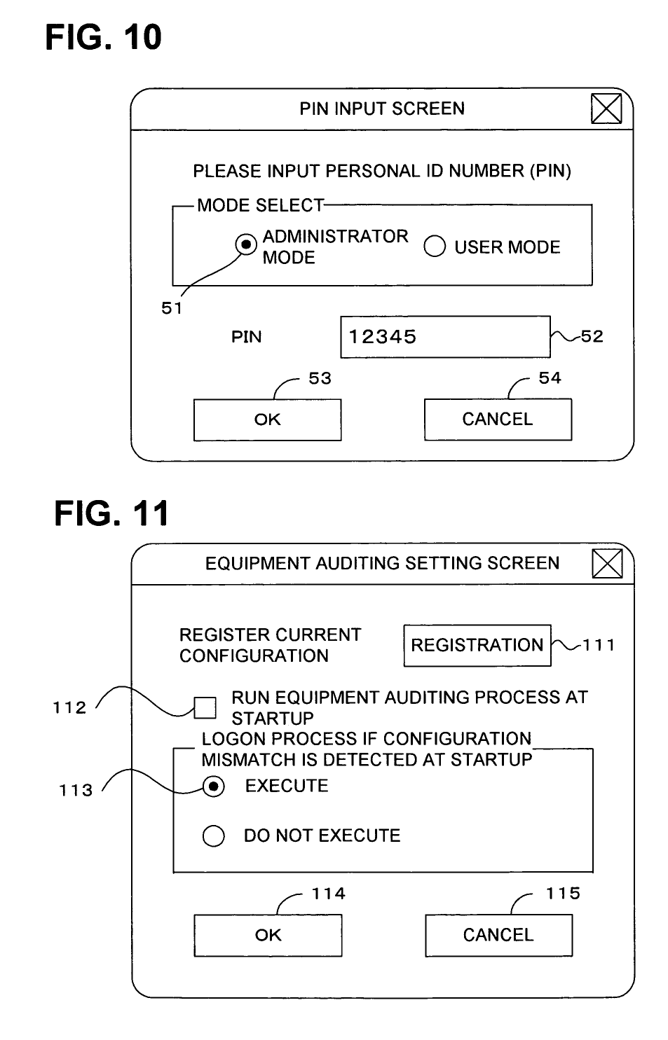

FIG. 10 is an example of a screen to be displayed in step S26. By clicking the radio button 51, either administrator mode or user mode can be selected. In the PIN column 52, the PIN which was input by the user is displayed. If the OK button 53 is clicked, the input is fixed, and a comparison with the password corresponding to the respective mode is performed, and if the cancel button 54 is clicked, the PIN can be re-input.

In FIG. 5, if the user selects the administrator mode (YES in S27), the logon processing section 21 judges whether the code number (PIN) which was input in step S26 matches with the administrator PIN (administrator password 109) (S30). If there is a match with the administrator password 109 in step S30 (YES in S30), the logon processing section 13 overwrites the registered configuration hash value 102 with the current configuration hash value 101 acquired in step S8 (S31).

FIG. 11 is an example of the screen displayed in step S31. By pressing the registration button 111 shown in FIG. 11, the registered configuration hash value 102 is overwritten with the current configuration hash value 101. In this way, the registered configuration hash value becomes the same value as the current configuration hash value even if these values are different, so the next equipment auditing succeeds unless the configuration is changed.

The check box 112 in FIG. 11 corresponds to the equipment auditing execution flag included in the status information 103, and the radio button 113 corresponds to the logon enable flag included in the status information 103. By checking the check box 112, the equipment auditing execution flag becomes 1, and equipment auditing is executed at startup. If “execute” is selected by the radio button 113, the logon enable flag becomes 1, and logon is enabled even if equipment auditing failed. FIG. 11 is called up by the users in a status where logon to the OS succeeded, and is also used to freely change the setting.

In FIG. 5, if there is a mismatch with the administrator password 109 in step S30, shutdown processing, the same as step S14, is executed (S14).

In this way, if there is a match with the administrator password, special authorization is given and the current equipment configuration can be regarded as the equipment configuration at registration. In the next and later equipment auditing, a current configuration match with the configuration at registration and entering logon disabled status can be avoided.

If the user mode is selected in step S27 (NO in S27), the logon processing section 21 judges whether the code number (PIN) which was input in step S26 matches with the user password 110 (S28), and if it matches (YES in S28), the temporary use hash value 108 stored in the smart card and the current configuration hash value 101 are compared, and if they match (YES in S29), it is judged as a logon success, and use of the OS is authorized to the user (S22).

In the flow charts in FIG. 3 to FIG. 5, the logon processing section functions as the authorization section for authorizing use of an application program and use of the information processing unit based on the result of equipment auditing, and as the security code information verification section for verifying the security code information, such as a password, stored in the storage section for authorizing use with the security code information that was input when equipment auditing is not executed.

In these flow charts, even if equipment auditing failed (NO in S9) or if equipment auditing was not executed (NO in S5), logon succeeds by the input of the access password (MATCH in S19→S22), so the security level is somewhat low. If a higher security level is desired, it is preferable that the logon enable flag included in the status information 103 is set to OFF in advance, or processing returns to step S15 if there is no match with the emergency password in step S17 when the result of equipment auditing is a mismatch or when equipment auditing is not executed.

As described above, according to the present embodiment, even if the security chip is turned OFF and the encryption function cannot be used, for example, when the equipment configuration is changed and the equipment auditing failed because of the difference of the equipment configuration at registration and the current equipment configuration, logon to the OS can be authorized for the user by inputting an emergency password.

Also in logon processing using the encryption function of the security chip, when the equipment auditing function detects mismatch between current configuration and registered configuration, for example, input of an access password is requested to enable the encryption function, and logon processing is executed by decrypting the encrypted account information only when an accurate access password is input, so the security level against the stealing of account information can be increased.

An effect similar to the above can also be obtained by implementing the operation of the information processing unit of the present embodiment as a method or program.

The present embodiment described authorizing the execution of a program which operates on the information processing unit 10, but the present invention may be applied to authorizing execution of a program which is executed by another information processing unit that can communicate with the information processing unit 10 and which the user can operate via the information processing unit 10. Authorization of execution may be for the entire information processing unit 10, or for a part of the information processing unit 10.

The equipment auditing in the present embodiment authorizes execution when the information matches perfectly, but may be authorized when a part of the information matches if allowed by the security level.

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

1. An information processing unit, comprising:
an auditing section auditing whether a configuration of the information processing unit has been changed based on a predetermined equipment configuration information on the configuration of the information processing unit;
an authorization section authorizing execution of a program and/or use of said information processing unit based on an audit result of said auditing section;
a storage section storing security code information; and
a security code verification section verifying security code information of said storage section and a security code information which was input for authorizing said execution and/or said use when auditing of said auditing section is set as not to be executed.

2. An information processing unit, comprising:
an auditing section collecting first configuration information on a current configuration of the information processing unit and auditing; and
a first authorization section authorizing execution of a program and/or use of said information processing unit based on an audit result of said auditing section, wherein
an external storage device storing second configuration information with which said execution and/or said use is authorized is connected,
further comprising a second authorization section comparing said first configuration information and said second configuration information when said execution and/or said use is not authorized by said first authorization section, so as to judge the authorization of said execution and/or said use.

3. The information processing unit according to claim 2, further comprising a storage section storing third configuration information with which the execution and/or the use of the information processing unit is authorized, wherein
when said first authorization section compares said first configuration information and said third configuration information and cannot authorize said execution and/or said use, said first authorization section compares said first configuration information and said second configuration information.

4. The information processing unit according to claim 2, wherein said external storage device is a portable storage medium that is removable from a reader.

5. The information processing unit according to claim 1, wherein said program is a program that is executed by the information processing unit.

6. The information processing unit according to claim 2, wherein said program is a program that is executed by the information processing unit.

7. The information processing unit according to claim 5, wherein said program is an operating system.

8. The information processing unit according to claim 5, wherein said program is a program that was sent from another information processing unit to said information processing unit via a communication network.

9. The information processing unit according to claim 6, wherein said program is a program that was sent from another information processing unit to said information processing unit via a communication network.

10. The information processing unit according to claim 1, wherein said program is a program that is executed by another information processing unit which can communicate with said information processing unit, and that the user operates via said information processing unit.

11. The information processing unit according to claim 2, wherein said program is a program that is executed by another information processing unit which can communicate with said information processing unit, and that the user operates via said information processing unit.

12. The information processing unit according to claim 1, wherein authorization of use of said information processing unit is for a part or whole of said information processing unit.

13. The information processing unit according to claim 2, wherein authorization of use of said information processing unit is for a part or whole of said information processing unit.

14. The information processing unit according to claim 1, wherein said configuration is regarding to hardware and/or software.

15. The information processing unit according to claim 2, wherein said configuration is regarding to hardware and/or software.

16. A storage medium in which a program causing a computer to execute a security code verification procedure is stored,
wherein said computer comprises an auditing section auditing whether a configuration of the computer has been changed based on a predetermined equipment configuration information on the configuration of the computer, and an authorization section for authorizing execution of a program and/or use of said computer based on an audit result of said auditing section, and
wherein in said code verification procedure, a security code information stored in a storage section for authorizing said execution and/or said use and the security code information which was input are verified when auditing of the auditing section is set not to be executed.

17. A storage medium in which a program causing a computer to execute a security code verification procedure is stored,
wherein said computer comprises an auditing section collecting first configuration information on a current configuration of the computer and auditing, and an authorization section authorizing execution of a program and/or use of said computer based on an audit result of said auditing section,
wherein said computer is connected to an external storage device for storing second configuration information with which said execution and/or said use is authorized; and
wherein in said authorization procedure, the authorization of said execution and/or said use by comparing said first configuration information and said second configuration information is judged when said execution and/or said use is not authorized by said authorization section.

18. The storage medium according to claim 17, for causing the computer further execute:
a first comparing procedure in which said authorization section compares said first configuration information and a third configuration information that is stored in a storage section and with that said execution and/or said use is authorized; and
a second comparing procedure in which said first configuration information and said second configuration information are compared when said execution and/or said use cannot be authorized based on result of the first comparison procedure.

19. The storage medium according to claim 17, wherein said external storage device is a portable storage medium that is removable from a reader.

20. The storage medium according to claim 16, wherein the program to be the target of said execution authorization is a program that is executed by the computer.

21. The storage medium according to claim 17, wherein the program to be the target of said execution authorization is a program that is executed by the computer

22. The storage medium according to claim 20, wherein the program to be the target of said execution authorization is an operating system.

23. The storage medium according to claim 21, wherein the program to be the target of said execution authorization is an operating system.

24. The storage medium according to claim 20, wherein the program to be the target of said execution authorization is a program that was sent from another computer to said computer via a communication network.

25. The storage medium according to claim 21, wherein the program to be the target of said execution authorization is a program that was sent from another computer to said computer via a communication network.

26. The storage medium according to claim 16, wherein the program to be the target of said execution authorization is a program that is executed by another computer which can communicate with said computer, and that the user operates via said computer.

27. The storage medium according to claim 17, wherein the program to be the target of said execution authorization is a program that is executed by another computer which can communicate with said computer, and that the user operates via said computer.

28. The storage medium according to claim 16, wherein authorization of use of said computer is for a part or whole of said computer.

29. The storage medium according to claim 17, wherein authorization of use of said computer is for a part or whole of said computer.

30. The storage medium to claim 16, wherein said configuration is regarding to hardware and/or software.

31. The storage medium to claim 17, wherein said configuration is regarding to hardware and/or software.
